(19) United States
(12) Patent Application Publication
(10) Pub. No.: US 2004/0120505 A1
(43) Pub. Date: Jun. 24, 2004

(54) Method and apparatus for providing a voiced call alert

(75) Inventors: Michael D. Kotzin, Buffalo Grove, IL (US); James E. Womack, Bedford, TX (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/324,939

(22) Filed: Dec. 20, 2002

(51) Int. Cl. H04M 3/00; H04M 1/00

(52) U.S. Cl. 379/373.01

(57) ABSTRACT

A terminal 300 arranged to initiate a call or indicate an incoming call with a voiced alert and methods thereof, the terminal including a receiver 303 for receiving a signal corresponding to a call alert, a processor 309 for determining that the signal is a call alert signal corresponding to the voiced alert and for providing an alert signal corresponding to the voiced alert; and an audio transducer 317 coupled to the alert signal corresponding to the voiced alert for generating a user perceptible voiced alert. The terminal for initiating includes an audio transducer 321 for converting a caller party voiced signal to an alert signal and a processor 309 for generating a call alert signal corresponding to the alert signal; and a transmitter 305 for sending the call alert signal corresponding to the alert signal to a network and thereby to the called party.

### FIELD OF THE INVENTION

This invention relates in general to communication systems and equipment, and more specifically to a method and apparatus for providing a voiced call alert for incoming calls.

### BACKGROUND OF THE INVENTION

Call alerting is an age-old problem and various approaches are used to notify a called party that an incoming call is available. A POTS (plain old telephone set) or terminal generates the familiar ring. More recently service providers or carriers have provided a service referred to as caller ID (identification) whereby a telephone number and possibly name will appear on called terminals or telephones, including wireless or cellular terminals or devices. Those familiar with the service, even when a name appears, will recognize that it is really a calling terminal identifier and not a calling party or caller identifier.

More advanced terminals are available that provide a vocalized call alert message, such as a canned alert. One system or terminal contemplates allowing a terminal user to record a message and a phone number and when an incoming call from that number is presented to the terminal based on a match between the recorded number and the caller ID number the message recorded by the terminal user will be played as the call alert. Clearly a need exists for improved apparatus and methods for providing voiced call alerts.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts, a simplified and exemplary system diagram for setting a context within which the present invention may operate;

FIG. 2 depicts, a more generalized exemplary system diagram for setting another context within which the present invention may operate;

FIG. 3 depicts a block diagram of a preferred embodiment of a terminal suitable for providing a voiced call alert;

FIG. 4 depicts a ladder diagram of preferred processes used to set up a call with a voiced call alert;

FIG. 5 shows an exemplary call alert message in a Session Initiation Protocol format;

FIG. 6 illustrates a flow chart of a preferred method embodiment of using a voiced alert from an incoming call; and

FIG. 7 illustrates a flow chart of a preferred method embodiment of initiating a call with a voiced alert.

### DETAILED DESCRIPTION OF PREFERRED EMBODIMENTS

In overview, the present disclosure concerns communications systems that provide services and specifically communications services such as phone services to terminals that may be wired or wireless communications units or subscriber units or devices and users thereof. More particularly various inventive concepts and principles embodied in apparatus and methods for generating call alert signals that include voiced call alerts at a calling terminal and providing the corresponding voiced call alert at a called terminal are discussed and described. The communications systems and terminals of particular interest are those being deployed and developed that are suitable for packet data communications and services often referred to as voice over IP and the like. Various wireless systems suitable for supporting packet data communications and voice over IP include for example advanced versions of GSM (Global System for Mobile communications), GPRS (General Packet Radio System), CDMA 2000 (Code Division Multiple Access), integrated digital enhanced networks, 2.5 G or EDGE, and 3 G or W-CDMA (Wideband CDMA) and UMTS (Universal Mobile Telecommunications Services) systems or variations and evolutions thereof.

As further discussed below various inventive principles and combinations thereof are advantageously employed to generate voiced alerts at a calling party terminal and provide those voiced alerts at a called party terminal, thus providing a voiced alert that may be calling party specific and appropriate to the occasion, thereby alleviating various problems, such as improper identification of a calling party or impersonal call alerts that plague known approaches for call alerting while facilitating and improving user satisfaction, provided these principles or equivalents thereof are practiced and otherwise utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

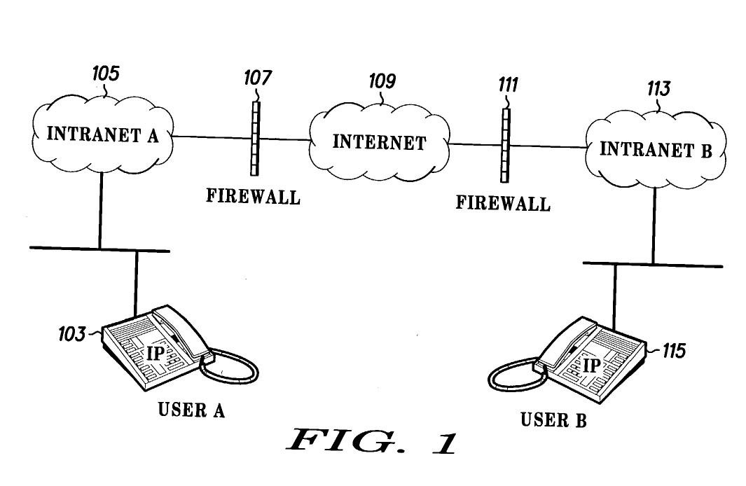

Referring to FIG. 1 a simplified and exemplary system diagram for setting a context within which the preferred embodiments may operate will be discussed and described. FIG. 1 shows a terminal 103, preferably an IP (Internet Protocol) phone or phone that is packet data compatible and operable for voice over IP operation, coupled via a network to an Intranet 105, such as an Enterprise wide area or local area network. The Intranet 105 is coupled via a firewall 107 to the Internet 109 and from there to another firewall 111. Behind firewall 111 is another Enterprise network or Intranet 113 coupled to another terminal 115 again preferably IP phone. FIG. 1 represents a relatively simple situation where the terminals are at known or fixed locations and know each other's IP address. This system may be used and is arranged to support a method of providing a voiced alert at a called party for incoming calls. For example, the Intranet 105 or servers and routers therein receive a call initiation message or request from a calling party via the calling terminal or terminal 103. The call initiation message, for example, may comprise a Session Initiation Protocol (SIP) Invite message including an encoded alert signal that corresponds to a voiced signal or alert from the calling terminal 103. The SIP invite, as is known, will include an indication of a destination or here an IP address and the call initiation message or SIP Invite will be forwarded to the called party, thereby providing the called party with an incoming call alert corresponding to or including the voiced alert or preferably an encoded voiced alert. Other network protocols, such as H.323 with signaling specification H.225 promulgated by the International Telecommunication Union may also support or be configurable or become configurable so as to support the voiced alert being forwarded from a user or calling party to another user or called party.

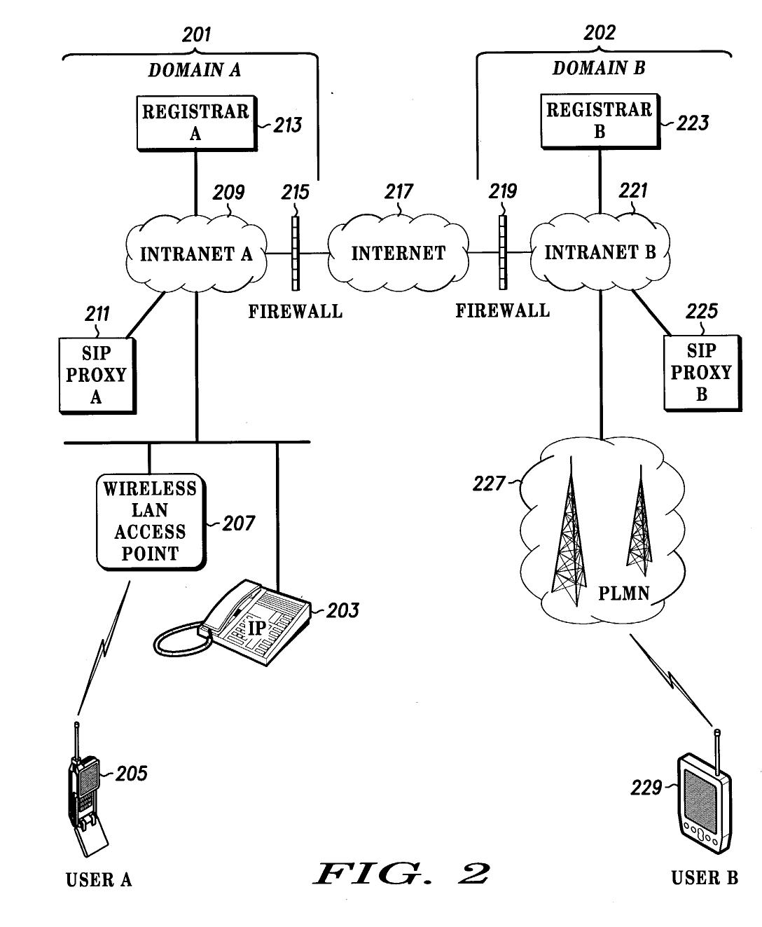

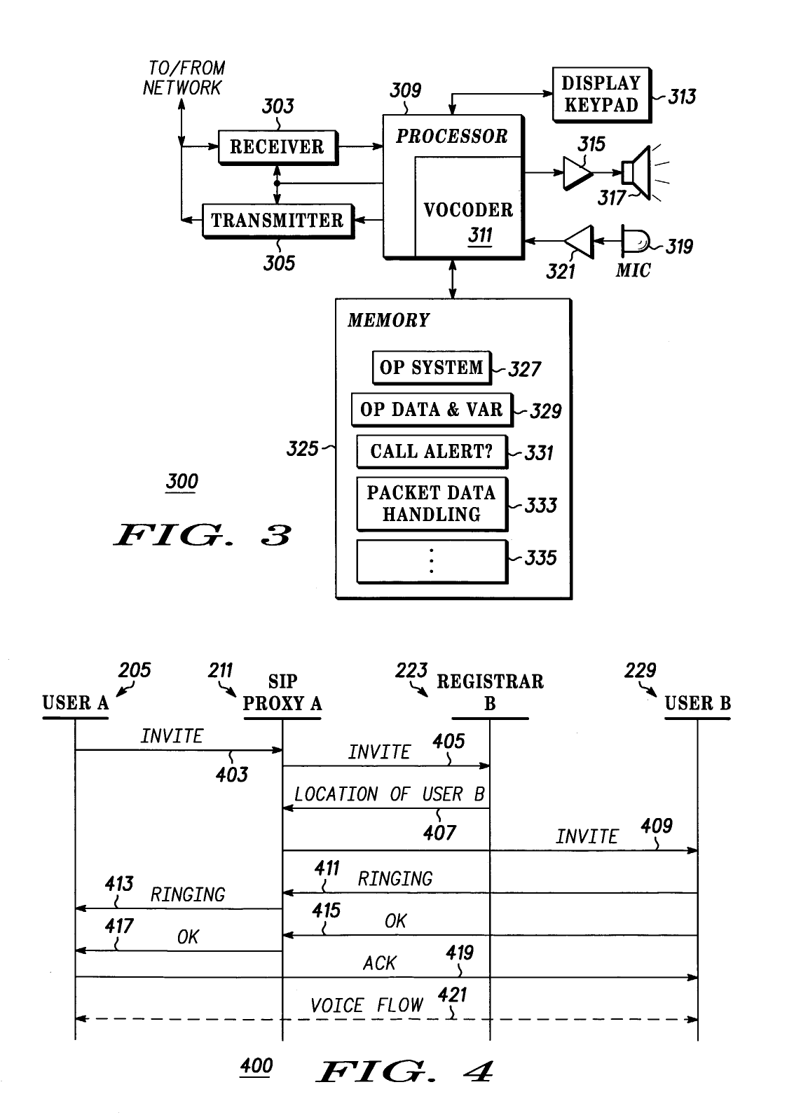

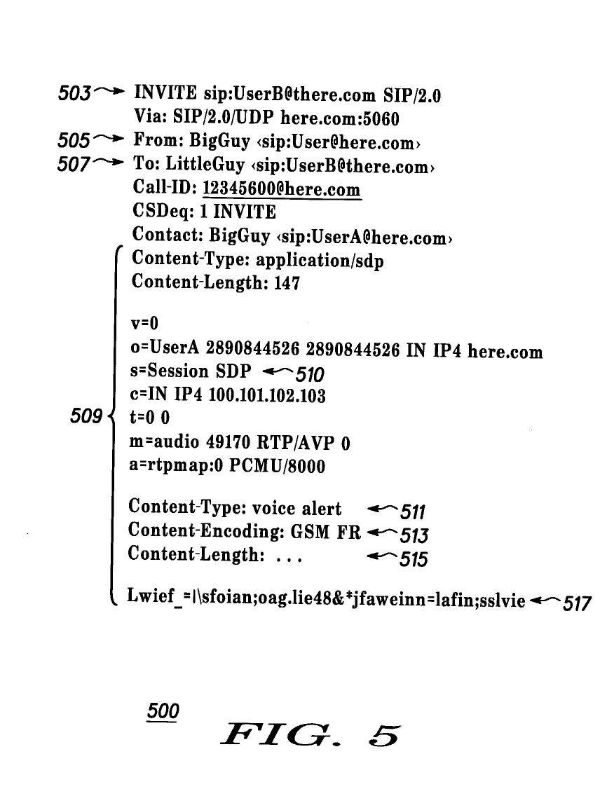

Referring to FIG. 2, a more generalized exemplary system diagram for setting another context within which the preferred embodiments may operate will be discussed and described. FIG. 2 shows Domain A 201 and Domain B 202. These domains may be different Enterprises or systems, etc. Domain A 201 includes a multiplicity of terminals, with terminals 203, 205 shown, that are each coupled to and inter coupled via a network shown generally as Intranet A 209. Terminal 203 is a fixed or stationary IP (internet protocol) phone. Terminal 205 (user A) is shown as a local area network (LAN) device, such as an IEEEA 802.11 or the like device, that is coupled via a wireless LAN access point 207, again likely one of many, that provides interconnections for such devices to the network or Intranet A 209. Domain A further includes, coupled to the Intranet 209, a Session Initiation Protocol (SIP) Proxy A 211 that operates, responsive to receipt of a SIP INVITE message from a terminal within Domain A, to determine a domain for a called party or the invited party, contacts the Registrar for the domain of the called party or invited party to obtain a current IP address, and then forwards the INVITE message to the called party at that IP address. Additionally a Registrar A 213 that provides a cross reference between user names, such as userA@domainA and one or more current IP addresses or other Identification information (phone number, etc.) that will resolve the present location of or for users within the Domain A or serviced by Registrar A 213. The Intranet A 209 is coupled by a firewall 215 to the Internet 217 and from there to various other servers, domains, etc. For example, Domain B 202 is behind another firewall 219 and includes a network or Intranet B 221 with a Registrar B 223 and SIP Proxy B 225, each operating and providing services similar to the corresponding functions of Domain A for users within Domain B. Domain B includes coupled to the Intranet B 221 a Radio Access Network or Public Land Mobile Network 227, such as a cellular phone or dispatch radio system, that provides services to a plurality of terminals or devices with terminal 229 (User B) shown. We will now consider the structure, function, and purposes of the terminals from both a receiving and sending perspective with reference to FIG. 3 and then return to some specifics of the transport with discussions of FIG. 4 and FIG. 5.

Referring to FIG. 3, a basic block diagram of a preferred embodiment of a terminal suitable for providing a voiced call alert will be discussed and described. From the terminals referred to in FIG. 2 it will be appreciated that the terminal may be a wireless unit or a wired unit. This block diagram is similar for either at the level needed to appreciate the advantages, concepts and principles of the present invention. The functions of many of the blocks are similarly known and will not be dwelled upon at any length. Generally, the block diagram of FIG. 3 depicts a terminal 300 that is arranged and constructed for, among other communications functions such as supporting and participating in a resultant call, indicating an incoming call with a voiced alert or initiating a call or outbound call with or having a voiced alert.

As depicted, the terminal includes a receiver 303 for receiving signals including a signal corresponding to a call alert and a transmitter 305 for sending a call alert signal including a portion corresponding to an alert signal, specifically a voiced alert signal from the calling party. The receiver 303 and transmitter 305 are coupled to and from a network 307. In those instances where the terminal is a wireless terminal or unit an antenna structure (not shown) will be the apparatus that provides the coupling to the network and the receiver and transmitter will be wireless receivers and transmitters. The receiver 303 and transmitter 305 are inter coupled to a processor 309 (controller and signal processor) by a control signal bus. Additionally the receiver provides a received signal to the controller for received signal processing or decoding and a transmit signal is provided by the controller to the transmitter for transmission as required. The processor 309 operates to control the transmitter and receiver and provide and receive proper signals to and from the transmitter and receiver. The processor further includes a vocoder 311 for encoding audio signals or decoding encoded signals to provide audio signals

The processor 309 is also inter coupled to a user interface that includes, for example, a display and keyboard 313, an amplifier 315 for driving a speaker 317 or earpiece, a microphone 319 coupled to an amplifier 321, and possible other user interface devices, such as a data port, etc. not shown but generally known. The speaker may be multiple such devices including, for example, a speaker for call alerts or speakerphone operation of the terminal and an earpiece for handset use. The amplifiers are shown coupled to the vocoder, as essentially all voice or audio signals will pass through the vocoder in the preferred packet data embodiment. These user interface elements operate as generally known to provide control and utility to a user of the terminal. The user interface will support, via the display and keyboard, user discretionary decisions and inputs as further noted below.

In any event the processor 309 comprises one or more microprocessors and digital signal processors suitable to perform the control and signal processing functions of the terminal with the specifics dependent upon protocols and signaling responsibilities. The processor 309 is further coupled to a memory 325 that is preferably a combination of RAM, ROM, EEPROM or perhaps magnetic based memory. The memory 325 stores software instructions and data that when executed and utilized by the processor 309 results in controlling the terminal and processing signals appropriately. The memory includes a basic operating system 327, operating variables and data 329, a call alert routine 331, a packet data handling routine 333, and various other routines 335 not specifically depicted such as routines for interfacing with the user interface and parameters and routines required to control the terminal that are not here relevant but will be understood by one of ordinary skill.

Generally, from a called terminal perspective the terminal as above noted is arranged to indicate an incoming call with or using a voiced alert that is included with the call alert signal. The receiver 303 is operable to and for receiving a signal corresponding to a call alert. The processor 309 is coupled to the receiver and operates to and for determining that the signal is a call alert signal, as aided and instructed by the call alert routines 331, and further for determining that the call alert signal includes or corresponds to the voiced alert. If so, the processor provides an alert signal corresponding to the voiced alert and then an audio transducer or the speaker 317 is coupled, by the amplifier 315, to the alert signal corresponding to the voiced alert and driven to generate a user perceptible or audible voiced alert.

As noted earlier, preferably, the receiver 303 is receiving a packet data signal and if this packet data signal is a call alert and if the packet data signal includes a portion that corresponds to a voiced alert all as determined by the processor using the packet data handling routines 333, preferably, the portion will be an encoded voiced alert. The processor 309 will route the encoded voiced alert to or through the vocoder 311 for decoding the encoded voiced alert to provide the alert signal which is then amplified and turned into an audible signal as above noted. One form or protocol that is particularly well suited for supporting this voiced call alert is the earlier introduced Session Initiation Protocol (SIP).

Thus, preferably the receiver 303 receives a packet data signal that is a known SIP Invite message where the SIP Invite message further comprises the encoded voiced alert and the processor 309, specifically vocoder 311 decodes the encoded voiced alert to provide the alert signal. The transmitter may be used for acknowledging (SIP:OK) the signal corresponding to the call alert. As noted above the receiver and the transmitter may be a wireless receiver and a wireless transmitter such as found in a cellular or local area 802.11 system. Thus the wireless receiver and the wireless transmitter can be suitable for supporting a packet data connection over either a wide area radio access network or a local area radio access network.

From a call initiation perspective the terminal is advantageously arranged and constructed to initiate a call or outbound call with or having a voiced alert that may be caller or calling party specific. The audio transducer or microphone 319 together with amplifier 321 is used to and operable for converting a caller party voiced signal to an alert signal corresponding to the voiced alert. The processor 309 is coupled to the audio transducer and operates to or for generating a call alert signal comprising a portion corresponding to the alert signal, where the call alert signal is intended for and addressed to a called party. The transmitter 305 may then be utilized for sending the call alert signal comprising a portion corresponding to the alert signal to a network and thereby via the network to the called party.

Preferably the terminal or the transmitter for sending the call alert signal will be sending a packet data signal. To do so, the processor 309 must insure that the alert signal from amplifier 321 is routed through the vocoder 311 for encoding the alert signal and then processor 309 generates the call alert signal comprising an encoded alert signal in packet data form as instructed by the packet data handling routines 333. Preferably, the processor will be generating a SIP INVITE message, addressed or directed to a called party and corresponding to or including a portion having the alert signal, preferably encoded alert signal provided by the vocoder. In this instance the receiver 303 may be used for receiving an acknowledgement (SIP:OK) of the call alert signal. The transmitter and the receiver may be a wireless receiver and a wireless transmitter that are suitable for supporting a packet data connection over either a wide area radio access network or a local area radio access network from a call initiation perspective as well. The vocoders and vocoding algorithms at the initiating and receiving terminals must be or be configurable to be compatible. This is handled by having the calling terminal indicate the proper vocoder to the called terminal.

With respect to sending a voice alert a variety of possibilities are contemplated. For example, the user of a calling terminal as part of initiating the call or call alert can select a voiced alert to be used for that call. The selection process may include recording a voiced alert that is of course caller specific and to the desired extent more or less specific to the intended caller or called party and circumstances of the call. For example, a predetermined key stroke pattern, such as a record button (not specifically shown) on the keypad 313 that may include or be facilitated by pull down menus and the like presented on the display 313 may be used to record a voiced alert. The voiced alert would be encoded by the vocoder 311 and used in the preparation of a packet data message by the processor 309. Alternatively, a prerecorded voiced alert stored in memory 325 in, for example, an avi format or more likely as encoded by the vocoder, can be selected from a plurality of prerecorded voiced alerts, again aided and facilitated by the keypad and perhaps menus on the display. For example, a user or caller may prefer a different voiced alert for business associates than for friends, family, or special friends or for different circumstances with each class. Additionally, it may make sense to allow for the possibility of no voiced alert even though the terminal is capable of one or for a generic or default alert when the user is in a hurry and does not wish to bother with selecting the best voiced alert or recording a new voiced alert.

At the called party or receiving terminal for a call alert message various possibilities are also contemplated. For example, the voiced alert may be proceeded by a more conventional attention getting call alert such as a ringing signal. Users may desire the ability to block voiced alerts from certain numbers or conditionally block such alerts. For instance a user may have to enter a pass code such as a predetermined keystroke pattern, such as 4-5-6, before the voiced alert will be forwarded or reproduced for the user. A user, in the interest of privacy or consideration for others for example, may prefer that a voiced alert only be played once a handset has been picked up, thus activated. It can also be arranged such that the calling party can determine various conditions of playback, such as the handset only activation or pass code only access. Other user desired features may also be implemented.

We will now review in somewhat more detail the setup and transport specifics with reference to FIG. 2, FIG. 3, FIG. 4, and FIG. 5. Referring to FIG. 4, a ladder diagram of preferred processes used to set up a call with a voiced call alert will be discussed and described. The specifics of FIG. 4 reflect a preferred protocol, specifically SIP, for initiating a call although it is expected that a similar ladder diagram specific to H.323 may also be utilized. The FIG. 4 ladder diagram shows the interactions between various entities of the FIG. 2 system level diagram. These entities are user A (terminal 205), SIP Proxy 211, Registrar B 223, and user B (terminal 229) and the ladder diagram shows basic signal flow for setting up a call, initiated by user A, between user A and user B. Note that a call initiated by user B will have an identical ladder diagram with all “A” entities replaced by “B” entities.

The call set up begins with user A 205 sending 403 a call alert message or signal or specifically a SIP:INVITE for user B to the SIP Proxy A 211. SIP Proxy A 211 forwards 405 the SIP INVITE to the Registrar B 223 where the address for user B is looked up and returned 407 to SIP Proxy A 211. Given the address for user B, the SIP Proxy A forwards 409 the SIP INVITE to user B 229. User B returns 411 a SIP:RINGING message to SIP Proxy A 211 and on 413 to user A. The RINGING indicates essentially that the call alerting process is underway or is an acknowledgment of the call alert signal. Next a SIP:OK from user B 229 is returned 415 to SIP Proxy A and then to 417 user A. The SIP:OK is an indication that the terminal at user B has recognized the call alert and answered the call or is willing to participate in a call. One of the functions of the OK or Ringing messages is that user A gets the address for user B. This is illustrated by the SIP:ACK message that basically completes the call setup processes. This message is sent 421 from user A directly to user B. Thereafter the call is conducted or voice flows 421 between user A and user B.

FIG. 5 shows an exemplary call alert message in a packet data, specifically, SIP format or SIP:INVITE format. At 503 user B is being invited by user A 505 to join a call 507. This call uses a streaming data protocol 509 as those of ordinary skill will recognize from the “s=Session SDP” command line 510. A content type line 511 specifies voice alert and will be recognized by the processor 309 as an indication of a voiced alert being included. Furthermore line 513 specifies the vocoder being used as a GSM full rate vocoder, thus telling the receiving terminal how to configure its vocoder in order to take advantage of the voiced alert. Line 515 indicates the length of the voiced alert as a number, here shown as . . . for exemplary purposes. Line 517 shows a string of alphanumeric or ASCII characters that is the encoded alert or specifically voiced alert in ASCII format.

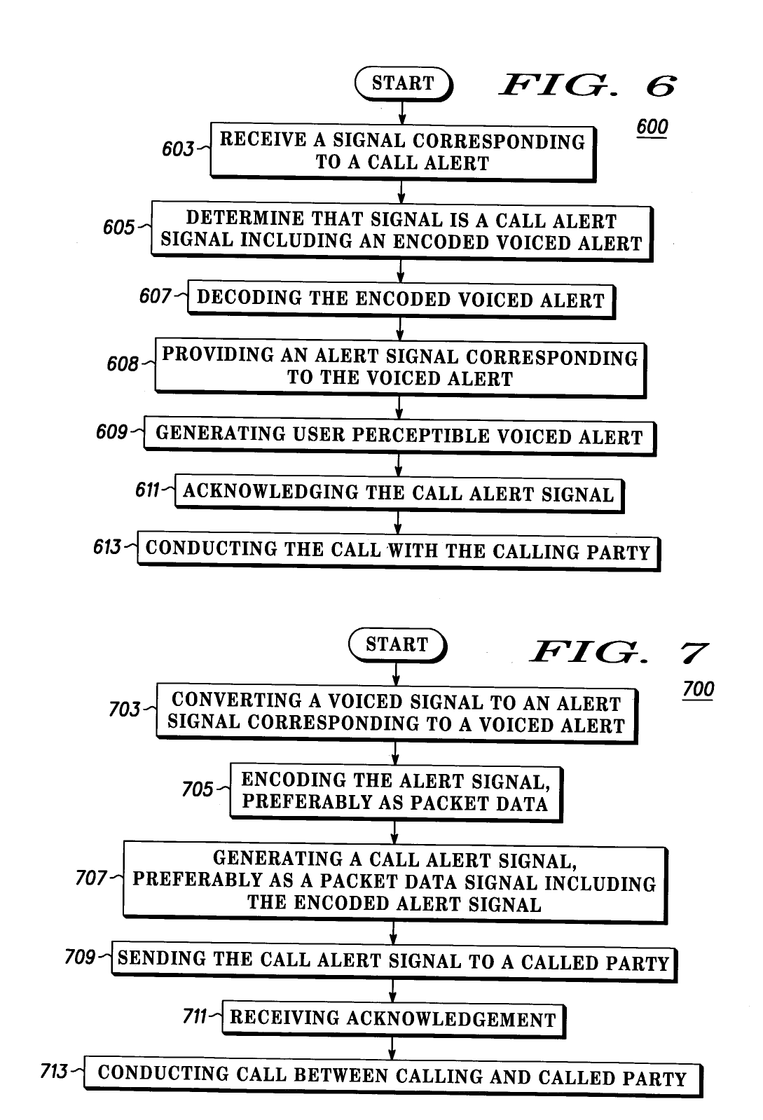

Referring to FIG. 6 a flow chart of a preferred method embodiment of providing and using a voiced alert from an incoming call will be discussed and described. Much of this discussion will be in the nature of a review as many of the concepts and principles have been discussed above. FIG. 6 shows a method 600 of indicating an incoming call with a voiced alert. The method starts and 603 shows receiving a signal corresponding to a call alert. Then 605 depicts determining that the signal is a call alert signal including a portion corresponding to the voiced alert, preferably an encoded voiced alert. Then 607 shows decoding the encoded alert signal or encode voiced alert. Next, 608 indicates providing an alert signal corresponding to the voiced alert and 609 shows generating a user perceptible voiced alert. After 609, the process at 611 shows acknowledging the call alert signal and 613 shows conducting the call with the calling party. Preferably the receiving the signal at 603 further comprises receiving a packet data signal comprising an encoded alert signal, and the providing the alert signal further comprises decoding the encoded alert signal to provide the alert signal. The receiving the packet data signal in one embodiment comprises receiving a Session Initiation Protocol (SIP) Invite message including the encoded alert signal. The receiving and the acknowledging may use a wireless connection over either a wide area radio access network or a local area radio access network.

Referring to FIG. 7 a flow chart of a preferred method embodiment of initiating a call with a voiced alert will be discussed and described. Much of this discussion will be in the nature of a review as many of the concepts and principles have been discussed above. FIG. 7 shows a method 700, preferably at a terminal, of initiating a call or an outbound call with the call having a voiced alert for alerting the called party. The method begins an at 703 converting a caller party voiced signal to an alert signal corresponding to the voiced alert is shown. Next, 705 shows encoding the alert signal, preferably as packet data. Then 707 indicates generating a call alert signal, preferably as a packet data signal comprising a portion corresponding to the alert signal, preferably encoded alert signal that is intended for a called party. Thereafter 709 shows sending the call alert signal comprising a portion corresponding to the alert signal to a network and thereby to the called party. The process at 711 indicates reception of an acknowledgment of the call alert signal. Next 713, shows conducting the call between the called and calling party.

The generating a call alert signal at 707 further comprises or includes the results of encoding the alert signal, at 705, by generating a packet data signal comprising an encoded alert signal that is sent as the call alert signal in the packet data signal form further comprising the encoded alert signal. The generating the call alert signal further, preferably, comprises generating a Session Initiation Protocol (SIP) Invite message comprising the encoded alert signal. Again as noted above the receiving an acknowledgement of the call alert signal or otherwise and the sending use a wireless connection over one of a wide area radio access network and a local area radio access network.

The processes and apparatus discussed above and the inventive principles thereof are intended to and will alleviate problems caused by prior art call alert systems and approaches. Using these principles and concepts, such as choosing or providing a voiced call alert signal specific to a calling party and specific for a called party for the terminals involved will enable a user of a terminal, such as a cellular handset, 802.11 handset, or voice over IP phone to enjoy calling party specific voiced alerts and likely more appropriate alerts or voiced alerts thus facilitating user satisfaction. It is expected that one of ordinary skill given the above described principles, concepts and examples will be able to implement other advantageous subscriber unit or system dependent procedures that may also facilitate performance benefits. It is expected that the claims below cover most such alternatives.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A terminal arranged to indicate an incoming call with a voiced alert, the terminal comprising:
a receiver for receiving a signal corresponding to a call alert;
a processor, coupled to the receiver, for determining that the signal is a call alert signal corresponding to the voiced alert and for providing an alert signal corresponding to the voiced alert; and
an audio transducer coupled to the alert signal corresponding to the voiced alert for generating a user perceptible voiced alert.

2. The terminal of claim 1 wherein the receiver for receiving the signal is further for receiving a packet data signal.

3. The terminal of claim 2 wherein the receiver for receiving further receives the packet data signal comprising an encoded voiced alert and the processor comprises a vocoder for decoding the encoded voiced alert to provide the alert signal.

4. The terminal of claim 2 wherein the receiver for receiving the packet data signal is further for receiving a Session Initiation Protocol Invite message.

5. The terminal of claim 4 wherein the Session Initiation Protocol Invite message further comprises an encoded voiced alert and the processor comprises a vocoder for decoding the encoded voiced alert to provide the alert signal.

6. The terminal of claim 1 further comprising a transmitter for acknowledging the signal corresponding to a call alert.

7. The terminal of claim 6 wherein the receiver and the transmitter are a wireless receiver and a wireless transmitter.

8. The terminal of claim 7 wherein the wireless receiver and the wireless transmitter are suitable for supporting a packet data connection over one of a wide area radio access network and a local area radio access network.

9. A terminal arranged to initiate an outbound call with a voiced alert, the terminal comprising:
an audio transducer for converting a caller party voiced signal to an alert signal corresponding to the voiced alert;
a processor, coupled to the audio transducer, for generating a call alert signal comprising a portion corresponding to the alert signal, the call alert signal intended for a called party; and
a transmitter for sending the call alert signal comprising a portion corresponding to the alert signal to a network and thereby to the called party.

10. The terminal of claim 9 wherein the transmitter for sending the call alert signal is further for sending a packet data signal.

11. The terminal of claim 10 wherein the processor further comprises a vocoder for encoding the alert signal and the processor generates the call alert signal comprising an encoded alert signal.

12. The terminal of claim 10 wherein the processor for generating the call alert signal further comprises the processor generating a Session Initiation Protocol Invite message corresponding to the alert signal.

13. The terminal of claim 12 wherein the processor further comprises a vocoder for encoding the alert signal and the processor generates the Session Initiation Protocol Invite message comprising an encoded alert signal.

14. The terminal of claim 9 further comprising a receiver for receiving an acknowledgement of the call alert signal.

15. The terminal of claim 14 wherein the transmitter and the receiver are, respectively, a wireless receiver and a wireless transmitter.

16. The terminal of claim 9 wherein the wireless receiver and the wireless transmitter are suitable for supporting a packet data connection over one of a wide area radio access network and a local area radio access network.

17. A method, at a terminal, of indicating an incoming call with a voiced alert, the method comprising:
receiving a signal corresponding to a call alert;
determining that the signal is a call alert signal including a portion corresponding to the voiced alert;
providing an alert signal corresponding to the voiced alert; and
generating a user perceptible voiced alert.

18. The method of claim 17, wherein the receiving the signal further comprises receiving a packet data signal comprising an encoded alert signal, and wherein the providing the alert signal further comprises decoding the encoded alert signal to provide the alert signal.

19. The method of claim 18 wherein the receiving the packet data signal further comprises receiving a Session Initiation Protocol Invite message including the encoded alert signal.

20. The method of claim 17 further comprising acknowledging the signal corresponding to a call alert and wherein the receiving and the acknowledging use a wireless connection over one of one of a wide area radio access network and a local area radio access network.

21. A method, at a terminal, of initiating an outbound call with a voiced alert, the method comprising:
converting a caller party voiced signal to an alert signal corresponding to the voiced alert;
generating a call alert signal comprising a portion corresponding to the alert signal that is intended for a called party; and
sending the call alert signal comprising a portion corresponding to the alert signal to a network and thereby to the called party.

22. The method of claim 21, wherein the generating a call alert signal further comprising encoding the alert signal and generating a packet data signal comprising an encoded alert signal and the sending the call alert signal further comprises sending the packet data signal comprising the encoded alert signal.

23. The method of claim 22 wherein the generating the call alert signal further comprises generating a Session Initiation Protocol Invite message comprising the encoded alert signal.

24. The method of claim 21 further comprising receiving an acknowledgement of the call alert signal and wherein the sending and the receiving use a wireless connection over one of a wide area radio access network and a local area radio access network.

25. A method in a system arranged to support a voiced alert at a called party for incoming calls, the method comprising:
receiving a call initiation message from a calling party, the call initiation message comprising a Session Initiation Protocol Invite message including an encoded alert signal that corresponds to a voiced signal from a calling terminal; and
forwarding the call initiation message to the called party, thereby providing the called party with an incoming call alert corresponding to the voiced alert.
